(19) United States
(12) Patent Application Publication
(10) Pub. No.: US 2018/0088754 A1
(43) Pub. Date: Mar. 29, 2018

(54) ELECTRONIC ECOSYSTEM PLATFORM

(71) Applicant: Moovila, LLC, Mount Pleasant, SC (US)

(72) Inventor: Michael J. Psenka, Sullivan's Island, SC (US)

(73) Assignee: Moovila, LLC, Mount Pleasant, CA (US)

(21) Appl. No.: 15/719,809

(22) Filed: Sep. 29, 2017

Related U.S. Application Data
(60) Provisional application No. 62/401,575, filed on Sep. 29, 2016.

(51) Int. Cl. G06F 3/0482; G06Q 10/06; G06Q 10/10

(52) U.S. Cl. CPC G06F 3/0482; H04L 12/1813; G06Q 10/103; G06Q 10/06311

(57) ABSTRACT

An interactive ecosystem and methods of using same that enables users to discover new information, collaborate with one another, and acquire necessary resources to complete projects.

### BACKGROUND OF THE INVENTION

### 1) Field of the Invention

The present invention relates to a smart content, mobile project and task management ecosystem platform, interactive user paradigm for content distribution and collaboration via multiple media sources, commerce and methods for using same.

### 2) Description of Related Art

Whether performing a task, such as buying a new home or trying to attain a goal across a multinational corporation, individuals need resources, a process and collaboration with other individuals or organizations to complete the task.

Accordingly, it is an object of the present disclosure to provide an interactive ecosystem platform with multiple uses across multiple types of projects and settings. In one instance, this may link stakeholders' duties to a mission in a meaningful way, delivering the knowledge and resources to execute their jobs, and allowing them to share their experience and knowledge with peers and collaborate on the execution of that procedure and/or process. The current disclosure provides a mobile project ecosystem and task management engine and interactive user paradigm for content distribution and collaboration via multiple media sources to help solve these persistent issues.

### SUMMARY OF THE INVENTION

A method performed by one or more processing devices. The method includes providing a project ecosystem containing a library of task media content to a user through an audio/visual display, presenting to the user via the audio/visual display, an option to select one or more task media content applications for review, and providing the user, via the audio/visual display, a task management engine, after one or more task media content has been selected. The task management engine informs the user of steps necessary to complete the task media content. Further, the task media content includes videos, written lists of information, audio files, weblinks, or combinations of the above. Still further, the user may save one or more media task content applications to a computer or server. Further yet, the project ecosystem, through the audio/visual display, allows the user to distribute the task media content to at least one other user. Yet still further, the project ecosystem, through the audio/visual display, allows the user to collaborate with at least one other user in order to complete the task media content. Furthermore, the project ecosystem, via the audio/visual display, allows a user to access providers of materials necessary to complete the steps dictated by the task management engine. Further yet, the task management system, via the audio/visual display, sends updates regarding progress of accomplishing the task media content.

In a further embodiment, a mobile project and task management ecosystem is provided. The ecosystem includes a collaboration platform for distributing and receiving a distributed task. The collaboration platform includes at least one communication channel for distributing a task and provides an items list and a steps list relating to the distributed task. The collaboration platform also includes a social learning functionality allowing input regarding the distributed task. The ecosystem also includes a smart content library function allowing personalized retrieval and storage of relevant instruction and resource definition for the distributed task. Further, the collaboration platform assigns different tasks to various users via the at least one communication channel. Still further, the project ecosystem, through the audio/visual display, allows the user to collaborate with at least one other user in order to complete the task. Further yet, the collaboration platform, via an audio/visual display, allows a user to access providers of materials necessary to complete the task. Still yet further, the collaboration platform, via an audio/visual display, sends updates regarding progress of accomplishing the task.

In a yet further embodiment, an interactive user paradigm is provided. The paradigm includes providing a collaboration platform, distributing a task via the collaboration platform, wherein the collaboration platform provides at least one media channel relating to the task, providing a two-way messaging center within the collaboration platform, and allowing modification of the task via social learning functionality. Further, social learning functionality is accomplished via harvesting information via the two-way messaging center from a user of the interactive user paradigm. Further yet, the collaboration platform enables access to a third-party website and the ability to retrieve and display content from the third party website. Still furthermore, the collaboration platform, through an audio/visual display, allows a user to collaborate with at least one other user in order to complete the task media content. Further still, the collaboration platform, via an audio/visual display, allows a user to access providers of materials necessary to complete the task dictated by the collaboration platform. Even further, the collaboration platform, via an audio/visual display, sends updates regarding progress of accomplishing the task.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a diagram of one embodiment of a platform ecosystem of the current disclosure.

FIG. 2 shows one embodiment of the current disclosure where the platform ecosystem has dual usage for commercial and social purposes.

FIG. 3 illustrates one possible embodiment of an ecosystem platform of the current disclosure provided via a mobile application.

FIG. 4 illustrates one embodiment of screen shots of a mobile platform showing how a user may use an ecosystem platform of the current disclosure to select a mortgage lender in order to purchase a new home.

FIG. 5 displays one embodiment of a mobile application of the current disclosure.

FIG. 6 displays one embodiment of search functionality of the current disclosure.

FIG. 7 illustrates a bundle of search results provided by one embodiment of the current disclosure.

FIG. 8 shows promotions the current disclosure may provide to a user.

FIG. 9 display one embodiment of a search result of the current disclosure.

FIG. 10 illustrates one embodiment of using a platform of the current disclosure to share a particular task with various individuals.

FIG. 11 shows assigning tasks to various individuals via a platform of the current disclosure.

FIG. 12 shows a message center for one embodiment of the current disclosure.

FIG. 13 shows a user profile that may be generated by one embodiment of the current disclosure.

FIG. 14 shows a system for allowing a creator, artist or author to make content actionable for their audience.

FIG. 15 shows one embodiment of a steps list schematic for completion of a task.

FIG. 16 shows a productivity component of the current disclosure making content “actionable.”

FIG. 17 provides one example of publishing an inquired about task for consumption to a group of users.

FIG. 18 shows one embodiment of a process of the current disclosure.

FIG. 19 illustrates one example of a task that may be selected by a user.

FIG. 20 shows one embodiment of linking a larger project framework for users to coordinate activities for larger scale activities.

FIG. 21 shows a block diagram of a platform and computing device of one embodiment of the current disclosure.

FIG. 22 shows an example of a generic computer device and a generic mobile computer device, which may be used to implement the processes described herein.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

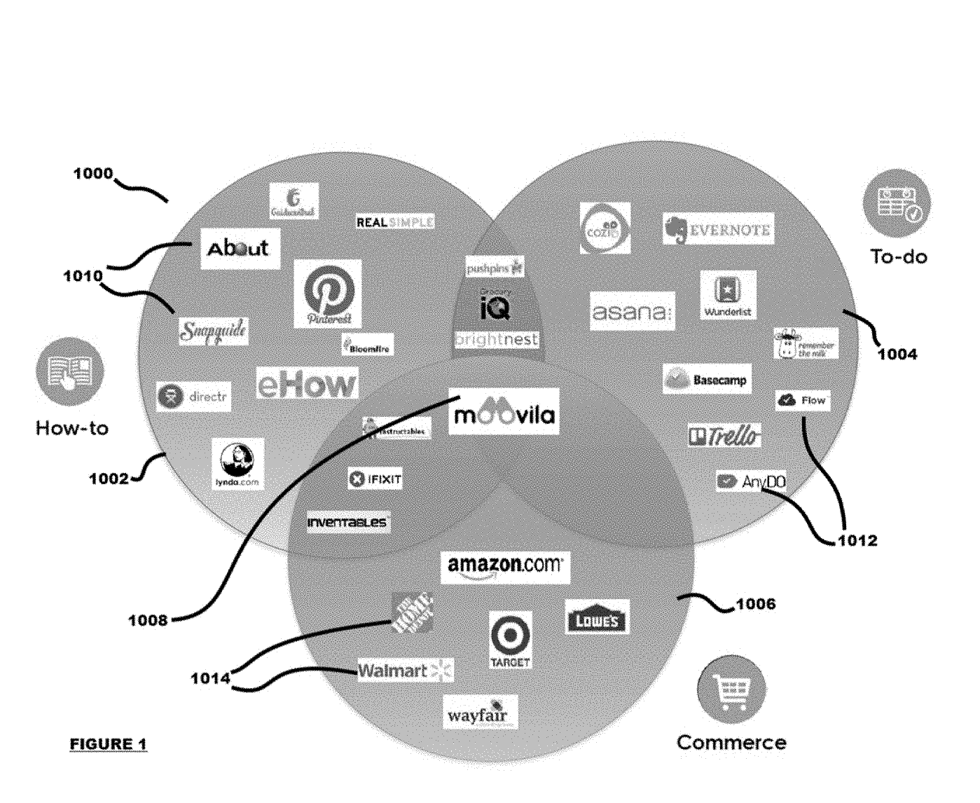

In one embodiment, an interactive ecosystem is provided that enables users to discover new information, collaborate with one another, and acquire necessary resources to complete projects. This is accomplished by uniting curated instruction (how-to) with productivity (to do) and commerce. FIG. 1 shows a yin diagram of how one ecosystem of the current disclosure functions. As FIG. 1 shows, ecosystem 1000 includes a how to module 1002, a to do module 1004, and a commerce module 1006 that may all be integrated through platform 1008. As FIG. 1 shows, how to module 1002 may include access to information sources 1010, for purposes of example only and not intended to be limiting, such as internet resources eHow, About, Pinterest, etc., that provide information to a user on how to achieve a specific goal. To do module 1004 may include access to internet scheduling functions 1012 such as asana, Basecamp, Flow, etc. Meanwhile, commerce module 1006 may include access to commerce functions 1014 such as Amazon.com, Target, Wal-Mart, etc. The integration of these three modules by platform 1008 thereby enables a user to devise a project, learn how to perform the project, and to obtain the items necessary to complete the project. In an alternative embodiment, platform 1008 may internalize the information and scheduling tasks such that this information is available to users without requiring use of third party websites and/or information sources.

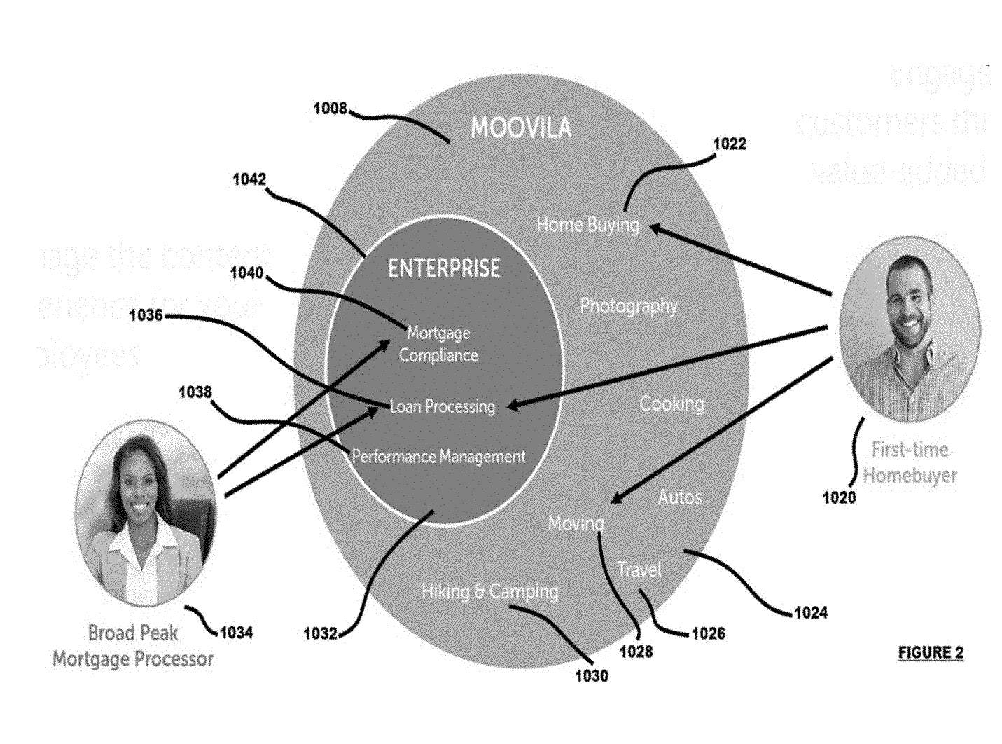

In a further embodiment, the current disclosure may be used as a dual platform for both commercial/business and social uses. FIG. 2 illustrates one such use. A user 1020 may be interested in a task 1022, such as buying a home. Platform 1008 through its social function 1024 allows user 1020 not only to investigate task 1022 but other items of interest 1026, 1028, 1030, etc., as well. Meanwhile, platform 1008 may include an enterprise function 1032, for purposes of example only and not intended to be limiting, such as a mortgage processor 1034. Enterprise function 1032 allows access by user 1020 to information regarding tasks such as loan processing 1036, which may also be accessed by mortgage processor 1034 using the platform from the commerce side of the application. Further, enterprise function 1032 may include functions solely accessible to mortgage processor 1034 such as performance management 1038 and mortgage compliance 1040, which hold no interest for user 1020 but may be accessed by mortgage processor 1034 in order to assist processor 1034 with various tasks that may or may not involve user 1020.

In this embodiment, platform 1008 may serve as both an information source for user 1020 but also for mortgage processor 1034. Indeed, enterprise function 1034, which should not be considered limited to the financial or mortgage industries but instead applicable over a broad spectrum of industries and consumers for same, may allow a company to provide information sources to employees. As shown by FIG. 2, a company may provide internal access only information 1042 within enterprise function 1032, such as mortgage compliance 1040 and performance management 1038, which are of interest to the company and its employees but not of interest to users. This internal access only information 1042 could be used by the company to improve employee performance, such as improving close rates on originations, allowing reduced processing times with consumers through the interaction of social function 1024 and enterprise function 1032, as well as educate employees via allowing them access to internally access only information 1042 in order to educate employees on items such as best practices and regulatory compliance. Further, the interaction between social function 1024 and enterprise function 1032 may allow ongoing contact between the company and customer such that cross-selling and other opportunities may be obtained, such as via analyzing the customer's use of social function 1024 in order to determine areas of interest to the customer that the company, or its affiliates, may be able to offer as a service or good.

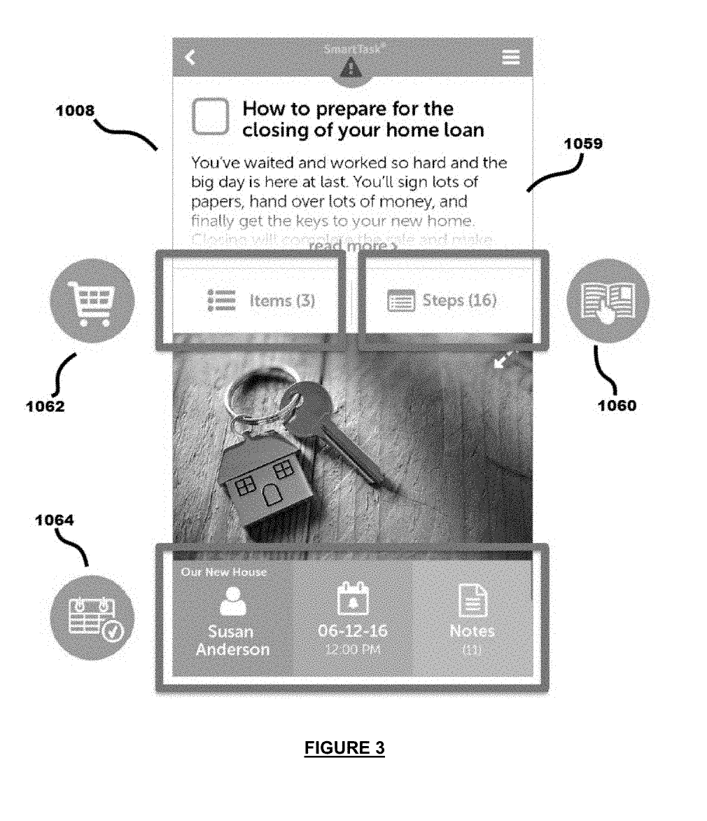

In a further embodiment, platform 1008 may be offered as a mobile application to allow user 1020 to communicate with mortgage processor 1034, or other employees for the commerce aspect, as necessary to assist user 1020 with completing the chosen task. FIG. 3 illustrates one possible embodiment of platform 1008 provided via a mobile application 1059 wherein a user may access how to information 1060, such as how to sale a house, prepare for a closing, etc., which in turn provides access to commerce information 1062, such as loan providers, mortgage companies, etc., as well as provides the user with to do items 1064 that inform the user of the steps required to complete the particular task. Commerce information 1062 may then be used to establish communication with a company or persons within the company that further assist the user with completion of the task.

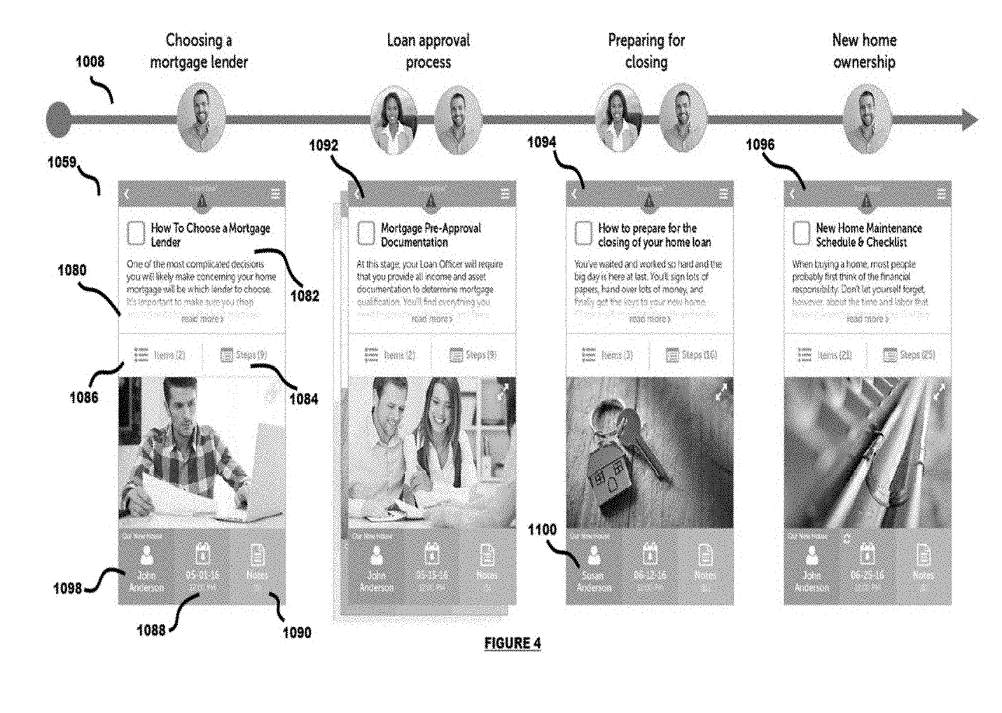

FIG. 4 illustrates one embodiment of screen shots of a mobile platform 1059 showing how a user may use platform 1008 to select a mortgage lender in order to purchase a new home. Screenshot 1080 shows a user has selected a How To 1082 regarding choosing a mortgage lender. Platform 1059 provides a To Do List 1084 that outlines the steps 1086 for selecting a mortgage lender as well as a Scheduler 1088 to maintain a timeline of activities and Notes 1090 that allow the user to record/describe/notate items regarding How To 1082. As FIG. 4 illustrates, additional Tasks 1092, 1094, and 1096 may be included with the original How To 1082 or performed separately. Indeed, one task 1082 may involve one or more subtasks, such as 1092, 1094, or 1096, necessary in order to complete task 1082. Further, tasks may be distributed or assigned to various individuals who may be identified by a an identifier 1098 with another user having a separate identifier 1100 so that tasks may be assigned to a single person or a group of individuals for completion.

With the ability to use platform 1008 in enterprise or commercial environment as well as a social/consumer based platform, user engagement can be enhanced as well as allow the enterprise environment to remain informed about a user's current needs and interests for cross-selling or services expansion opportunities.

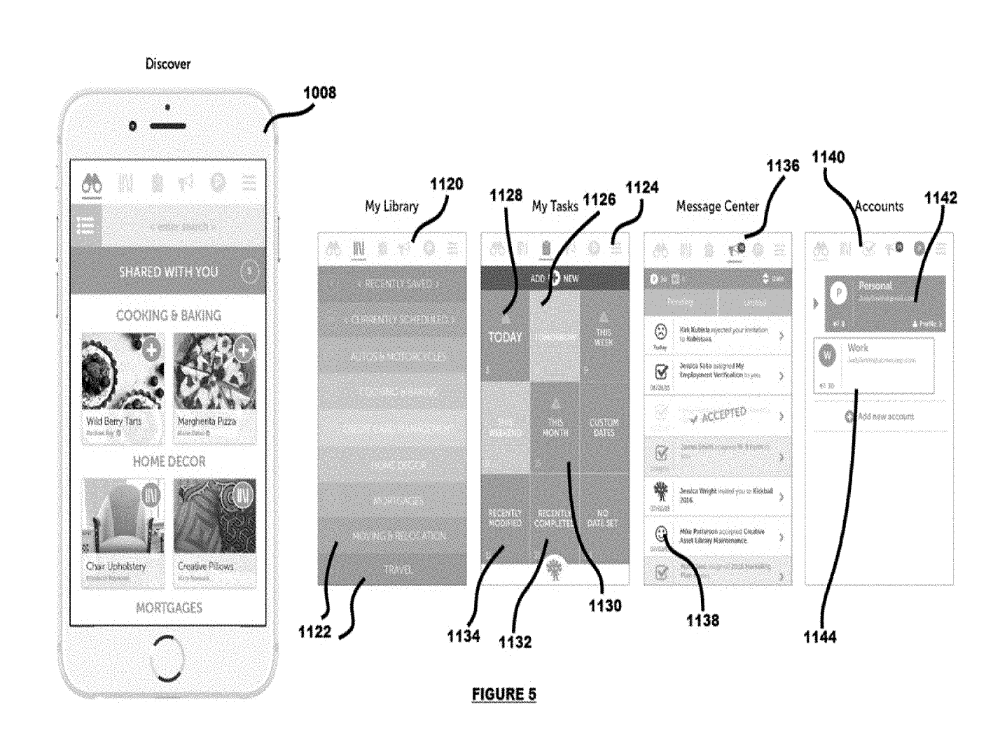

As FIG. 5 shows, platform 1008 may include a library 1120 of how to items 1122, a task scheduler 1124 showing items 1126 and dates 1128 for completion, ongoing tasks 1130, completed tasks 1132, and modified tasks 1134 as well as a message center 1136 for communication with other users 1138 of platform 1008. Indeed platform 1008 may provide dual functionality 1140 by allowing a user to select between personal platform accounts 1142 and work platform accounts 1144. While two accounts are discussed, more accounts are considered within the scope of this disclosure, which should not be considered limited to just two accounts. Further, separate accounts on the platform may be interlinked with one another so that interests in one account influence or guide interests in the other account, such as through suggestions, advertising, etc.

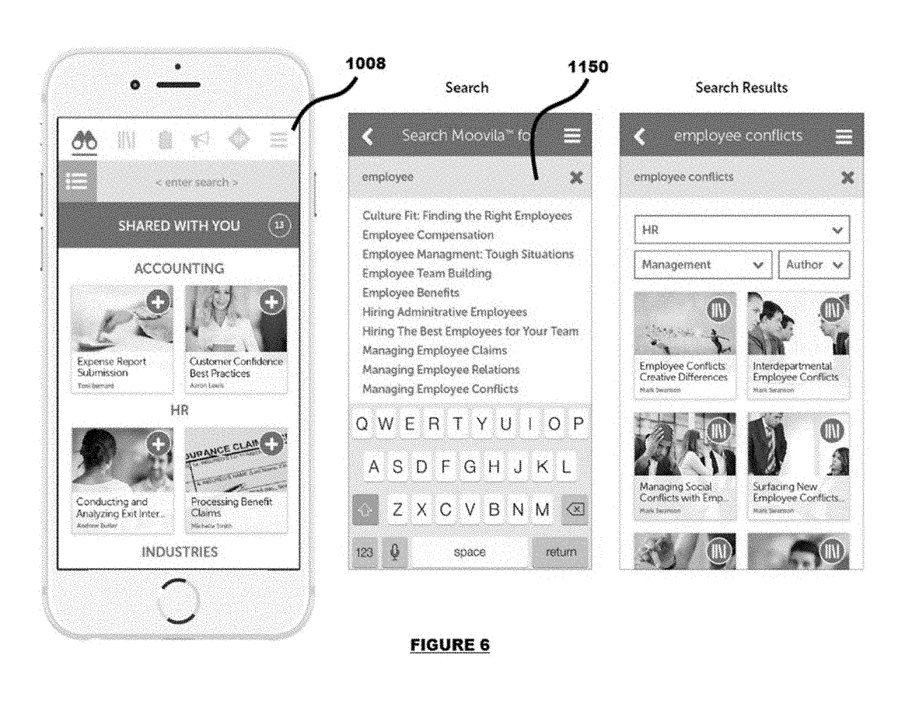

As FIG. 6 illustrates, platform 1008 may provide search functionality 1150 allowing users to search for topics of interest, either via external sources such as the internet or via an internal cache of information accessible via platform 1008. In a commercial setting, search topics may be relegated to business-related categories such as employee management, conflict resolution, team building etc., wherein in a social setting searches may be more open-ended or free form without limitations on search topics in place.

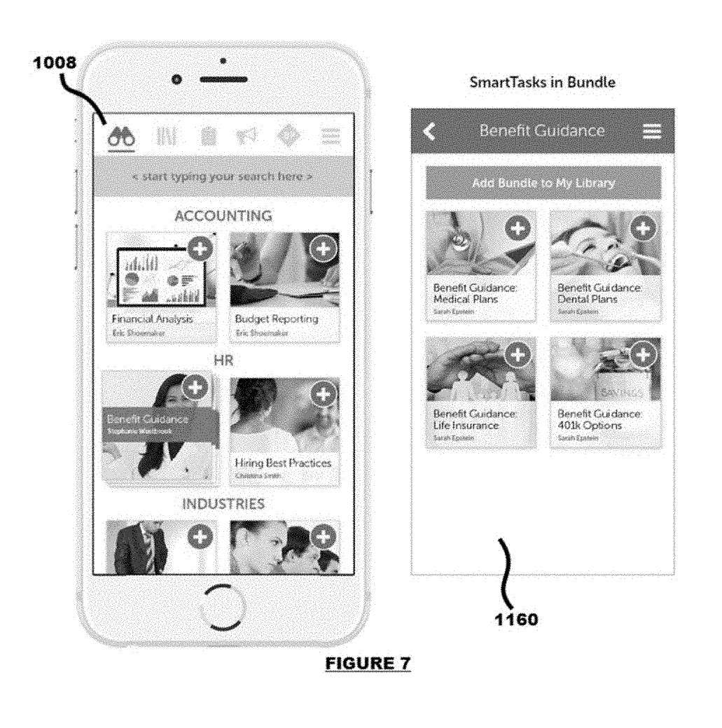

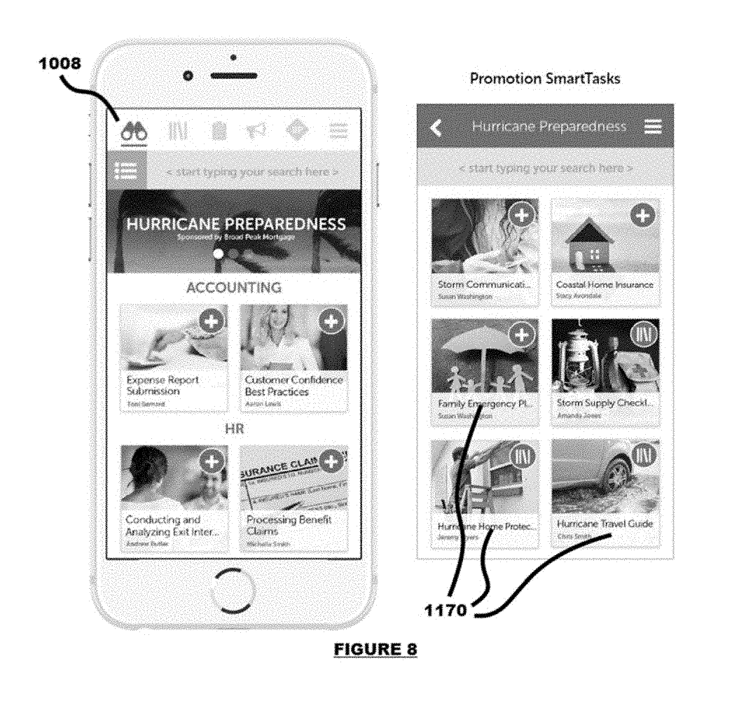

FIG. 7 illustrates another aspect of platform 1008 wherein a search may provide users with a bundle 1160 of related search topics. The user may select that the entire bundle be added to the user's library or simply select individual tasks from the bundle, as the user prefers. FIG. 8 shows that platform 1008, in either a commercial or social function, may provide promotions 1170 to the user. These promotions may be based on a search query or search results on platform 1008 or even promoted advertising unrelated to a search query or search result.

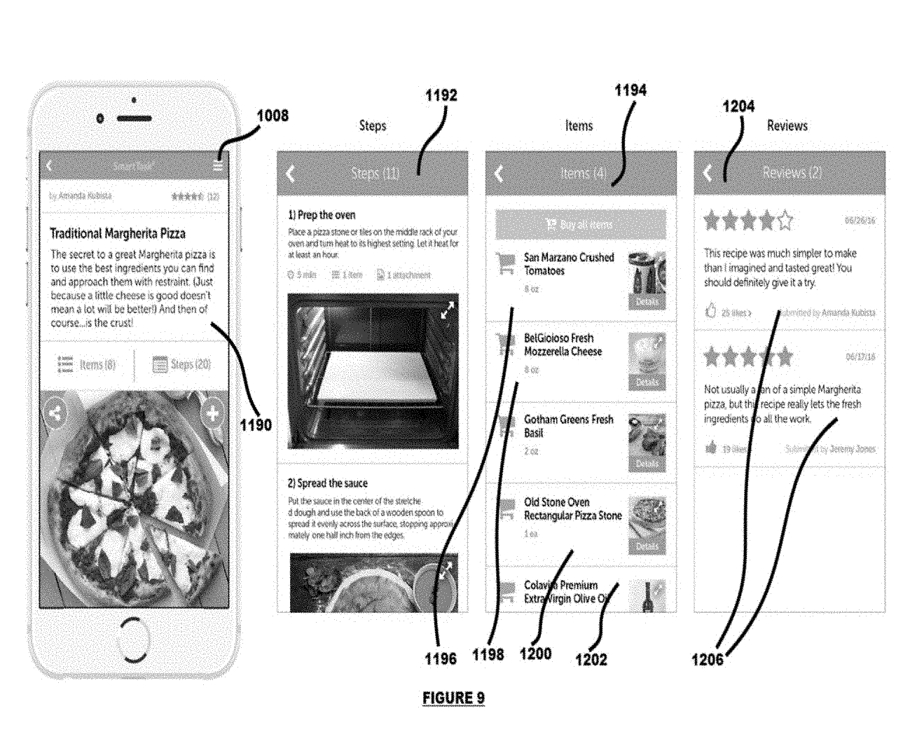

FIG. 9 illustrates one embodiment of a search result 1190. While this example displays a search regarding a food item, the current disclosure is not so limited and myriad search results are considered within the scope of the disclosure based on a user's search query. A search result 1190 may include a step or task list 1192 that details the process for completing the searched task. In addition, platform 1008 may also provide a listing of items 1194 needed to complete the task as well as links 1196, 1198, 1200, 1202, for purchasing the needed items. For instance, and not intended to be limiting, a recipe may include a listing of the ingredients needed as well as a means of ordering same through a commerce website by simply clicking on an item and providing shipping and payment information for the item. Platform 1008 may also include user input 1204. User input 1204 may vary based on if the platform is being used in a business/commercial or social setting and may include content 1206 such as best practices, suggestions, explanations of steps, comments regarding items, inquiries regarding the task, etc.

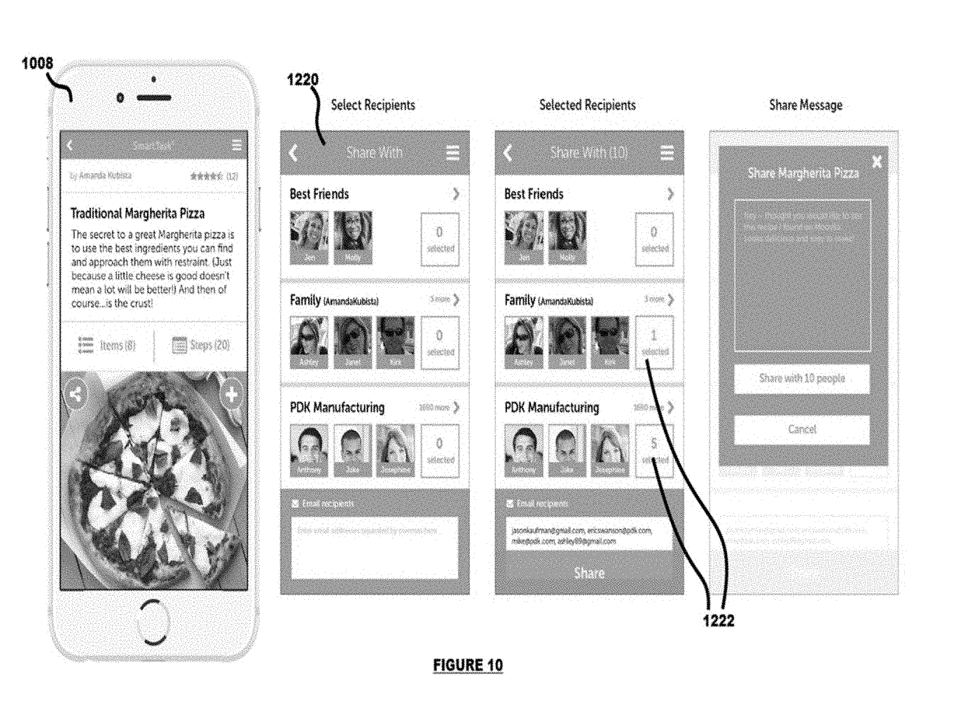

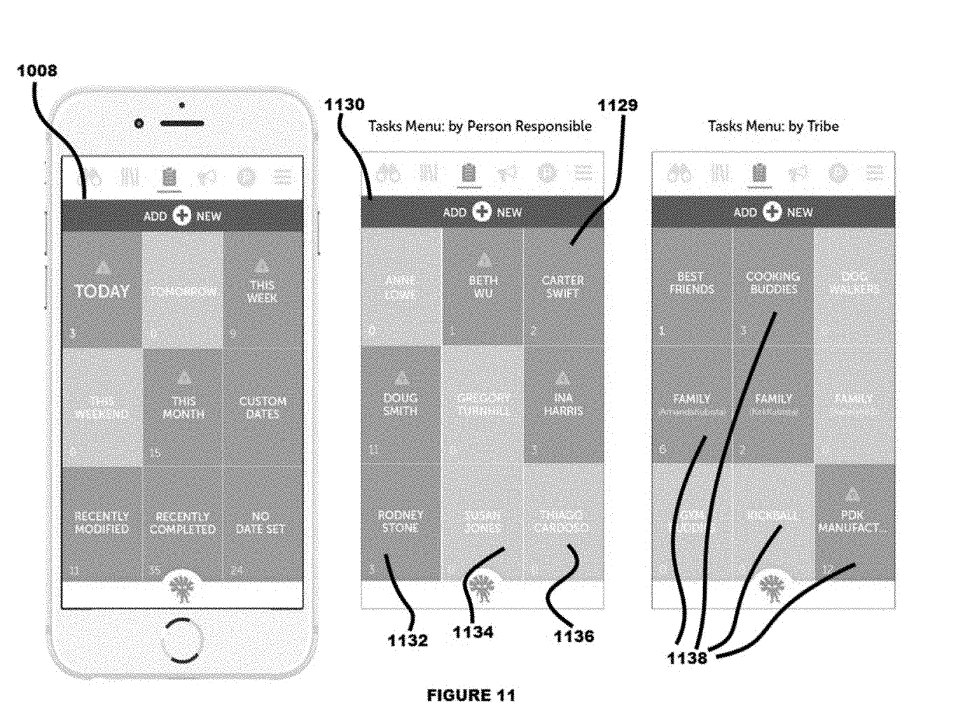

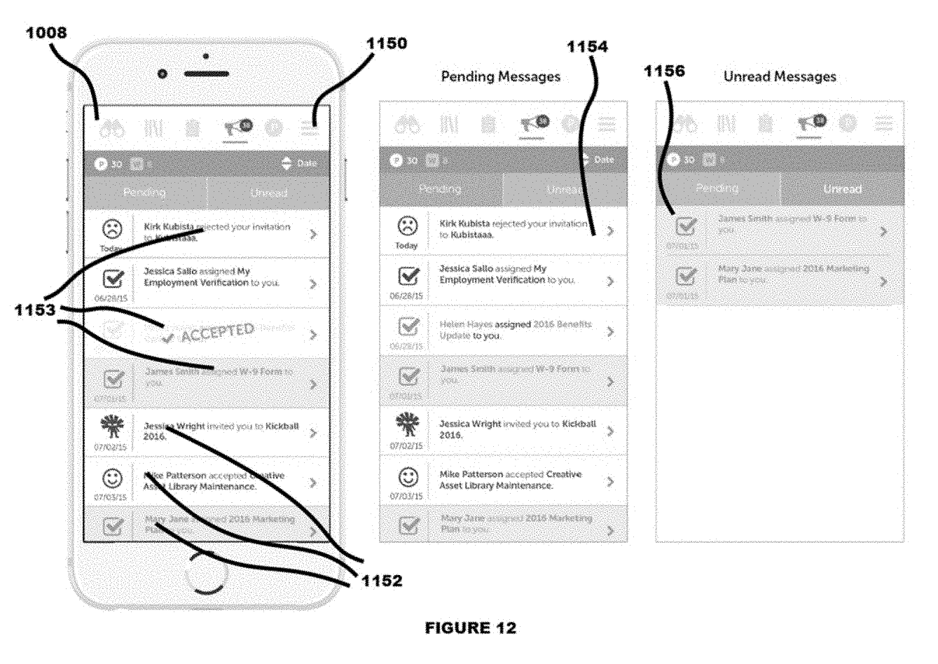

FIG. 10 illustrates one embodiment of using platform 1008 to share 1220 a particular task with various individuals 1222. This allows a user to send content to others that may be interested in performing the same or similar tasks. FIG. 11 illustrates another use of platform 1008. This entails assigning 1130 tasks 1129 to various individuals 1132, 1134, 1136, etc. Tasks may be also be distributed to individuals grouped in “tribes” 1138 based on an association between the members of the group such as family, common interests, employer, division of a company, social groups, etc. Assignment 1130 of tasks may include scheduled dates of completion, “pinging” those with a task to remind them of due dates, listing modified tasks a recipient is responsible for, showing completed tasks, reminding users of overdue tasks, etc., so that the users may cooperate to complete the task. FIG. 12 displays a message center 1150 for one embodiment of platform 1008. Message center 1150 may show recipients 1152 of various tasks, including the status 1153 of the task such as accepted, rejected, assigned, etc. Message center 1150 may also show pending messages 1154 and unread messages 1156, so that a user will have visual cues as to what messages have been addressed and which still require a response.

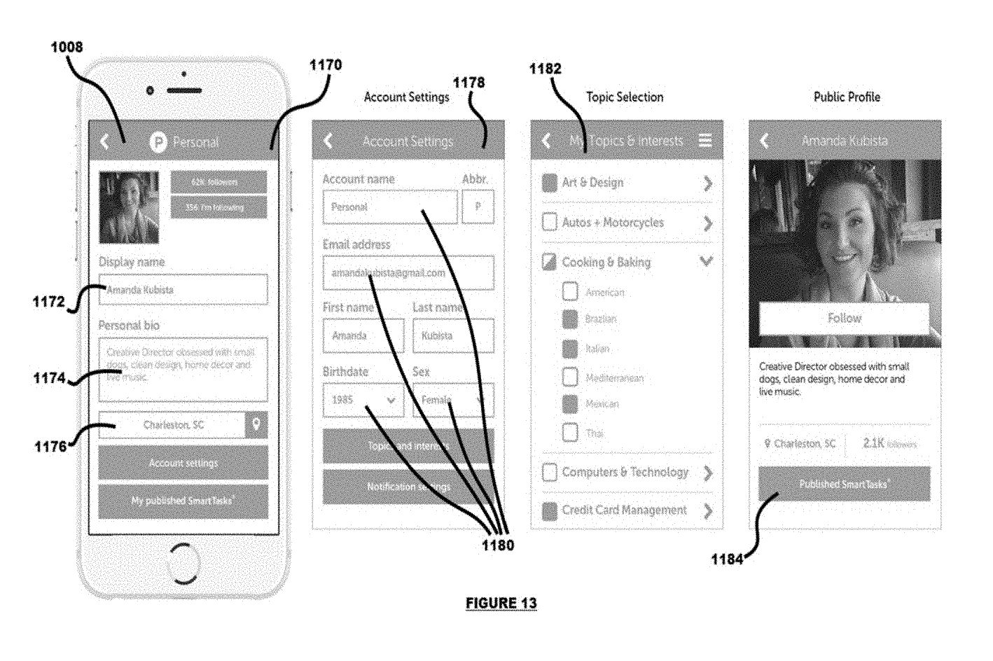

In a further embodiment, as shown by FIG. 13, platform 1008 may include a profile 1170 of a user. Profile 1170 may include user name 1172, user personal biography 1174, and user location 1176. Account settings 1178 may also be provided which enable the user to customize platform 1008 by supplying personal information 1180 such as emails, name, birthdates, gender, etc. Platform 1008 may also allow the user to choose topics of interest 1182, however, with commercial or business platform usage a user may be automatically included within certain groups or excluded from same depending in the business communications needed for their jobs. Platform 1008 may also include a listing of tasks the user has sent or assigned to others.

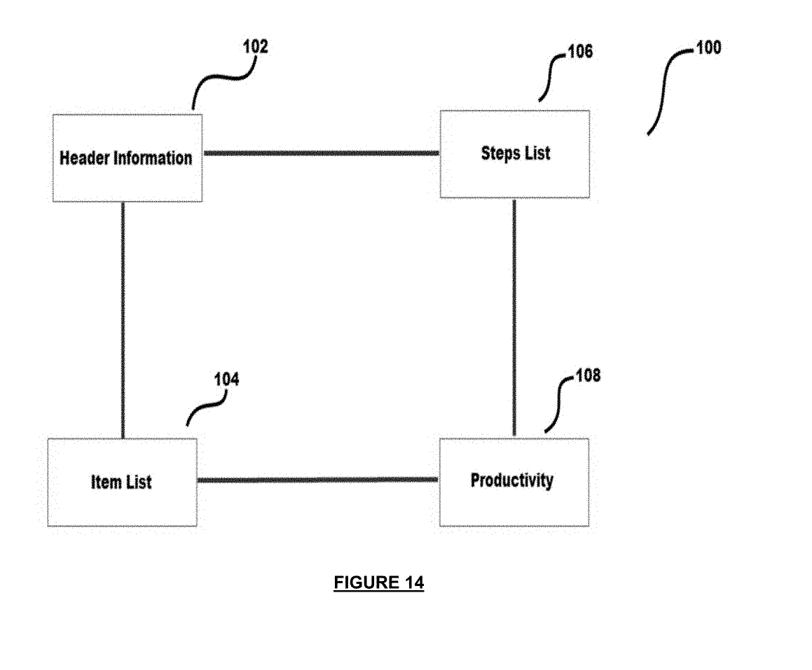

In a further embodiment, the current disclosure discloses an intelligent task platform. With respect to FIG. 14, in one embodiment, a platform is provided that seamlessly integrates the implementation of “how-to”, “to do” and commerce. The applications of this disclosure range from “do-it-yourself” projects, how-to inquiries, compliance, standard practice, local commerce, as well as additional applications.

In one embodiment, as shown via FIG. 14, the current disclosure provides a system 100 containing four components that allow a creator, artist or author to make content actionable for their audience. While four components are discussed, more or fewer components are considered within the scope of this disclosure, which should not be considered limited to just four components. Foremost, header information, i.e., what to do or what task the user wishes to accomplish is provided. Header Information 102 may contain the name of the process or task, e.g. Gluten Free Brownies, Oxygen Sensor Compliance, Loan Application Process, Establishing a Human Resources Department, Building a Deck from Composite Materials, etc. Header Information 102 may include descriptions of the process or task or tag information further describing the process.

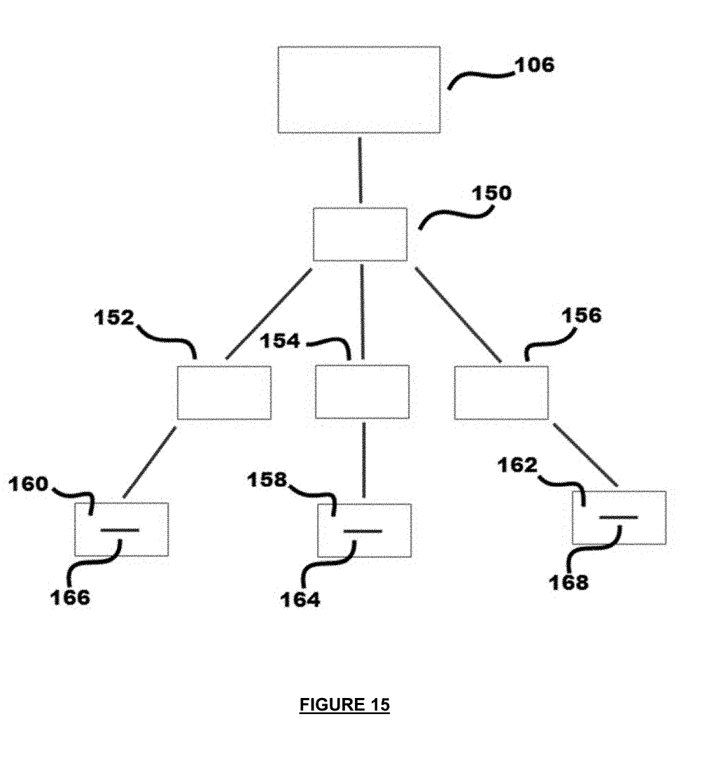

Items List 104 provides a detailed list of the items and/or resources required to complete the task described in the header, e.g., milk, eggs, micrometer, loan application, corporate structure outline and reporting responsibilities, nails, boards, saw, drill, etc. Steps list 106, see FIG. 15, provides a detailed list of items/actions necessary to complete the task. Productivity component 108 makes the content actionable by allowing collaboration between those assigning the task and those accomplishing it.

As shown in FIG. 15, steps List 106 may provide a detailed list of the steps required to complete the task or process. In one further embodiment, the steps may be provided in various levels keyed to the user's experience via a user selection 150. For example, an executive chef could select an “Expert” level at selection 150 and receive an expert steps list 152 while a novice baker could select a “Beginner” level of steps via selection 150 and receive a beginner steps list 154, which may be a more detailed list that provides more thorough instructions as the beginner would have less skill and experience than the users selecting more experienced categories. An experienced, but not expert, baker may select an “Experienced” steps list 156 at step 150.

The degree of information provided in each list 152, 154, and/or 156 may be curtailed or expanded to the self-described capabilities of the user. Steps Lists 152, 154, and 156 may provide the steps in a singular or combined media format. For example, a beginner chef may receive simply a text listing 158 of easy-to-follow directions for gluten free brownies. Meanwhile, an expert chef may receive audio/video/image/text or other media feed 160, made available as known to those of skill in the art, showing advanced cooking techniques, such as caramelizing the outer layer of the brownie using a chef's torch, that may be performed as well as images or videos showing an exemplary finished product for comparison purposes. Meanwhile, an experienced baker may receive a video feed 162 showing how to prepare the brownies from scratch. Steps lists 152, 154, and 156 may also contain links to the various items needed for the project. For instance, for beginner chefs, steps list 154 may contain link(s) 164 showing the user what eggs, canola oil, and cocoa powder look like. Link 164 may also link the user to commercial suppliers, via means known to those of skill in the art, showing where same may be found in a grocery store. This embodiment could include a “back level” commercial investment embodiment where vendors could pay for advertising to have their products suggested as choices to the user, regardless of skill level, or tuned specifically to various user skill levels. For instance, a high end appliance maker or provider of high-end organic produce being suggested to executive chefs via link 166, thereby incorporating a commercial advertising platform and generating advertising revenue via the platform. Indeed, link 168 could show the experienced but not expert user comparisons of products and the suppliers of same. Steps list 152, 154, and 156 may also include time estimates of the various steps so that users may estimate and allocate accordingly for each portion of the task.

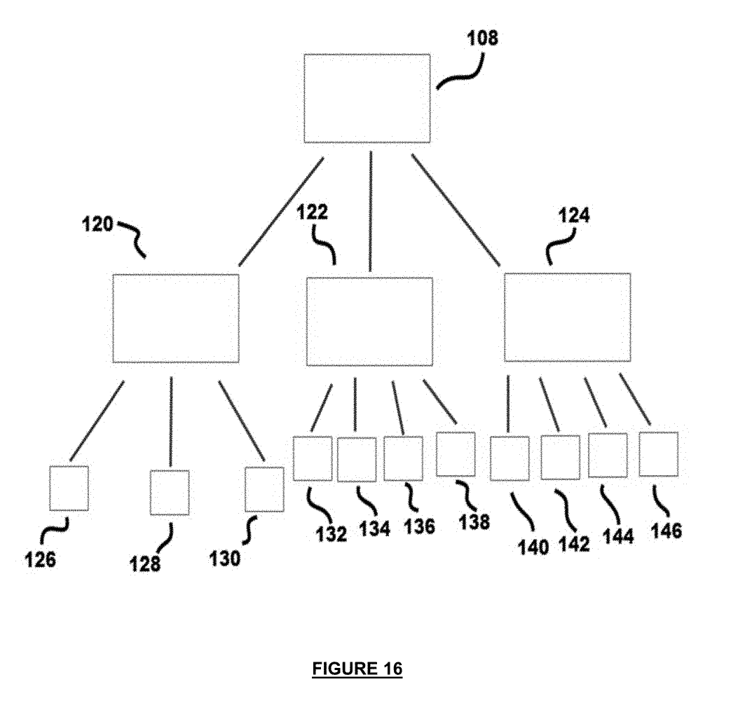

With respect to FIG. 16, productivity component 108 makes the content “actionable.” In one embodiment, productivity component 108 may be comprised of three sub components, while three components are discussed, more or fewer components are considered within the scope of this disclosure, which should not be considered limited to just three components. An ownership/assignment component 120 provides for allowing the user to assign content to a responsible party or group of parties. These parties may be further divided into groups or “tribes” of social productivity groups, for example Tribe 1 126, Tribe 2 128, and Tribe 3 130. Scheduling component 122 allows the user to assign dates/recurring dates for execution 132, as well as for reminders 134, push notifications 136 and status reporting 138 for any or all members of tribes 126, 128 and 130.

Collaboration component 124 allows the various members of tribes 126, 128, and 130 to comment 140, notate 142, update 144 and utilize multiple media 146, via means known to those of skill in the art, to collaborate on the assigned project.

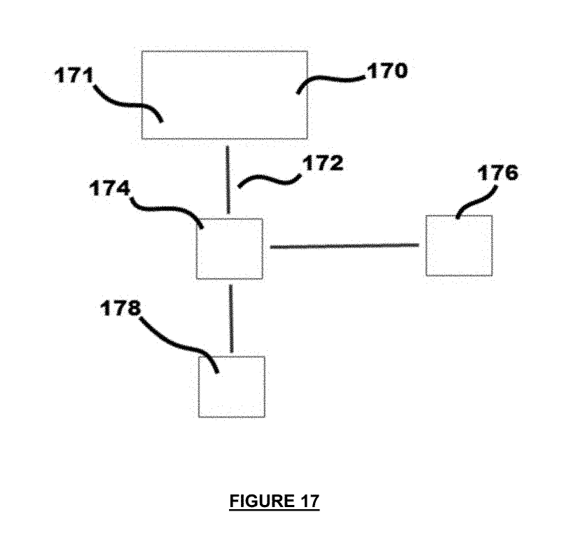

In a further embodiment, the current disclosure may provide a publication process that allows a user(s) to publish the inquired-about tasks, i.e., “SmartTasks,” for consumption to either private groups or public groups. The inquired about SmartTasks may be updated centrally and updates may cascade down to consumers utilizing a particular SmartTask. FIG. 17 shows one embodiment of this process. SmartTask 170 may be opened by a user and an invitation 172 sent to another user 174 from messaging center 171. This user may reject the invitation 176, thereby refusing to participate in the activity and ceasing the SmartTask for this user. Alternatively, the user may accept 178 the SmartTask and begin participation with same. In a further embodiment, rejection 176 may not be allowed and the SmartTask simply provided to the user(s) for participation.

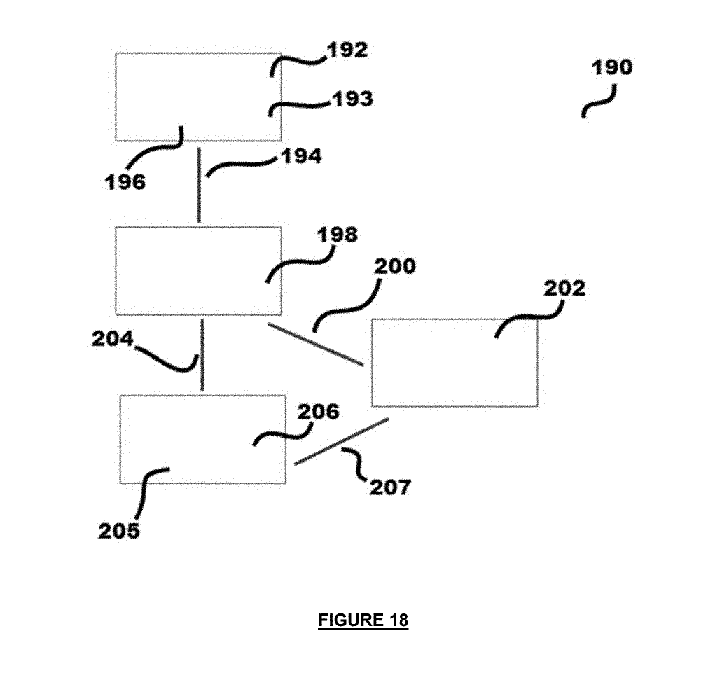

One embodiment of a process 190 of the current disclosure is shown via FIG. 18. A user, not shown, may review a library of SmartTasks 192 made available via a computer system/internet portal 193, etc., as known to those of skill in the art. As explained supra, library of SmartTasks 192 may include various informational topics along a vast plethora of technologies, commercial strategies, etc. A user may add 194 a specific SmartTask 196 that interests the user to a user library 198. The user may then assign 200 SmartTask 196 to other users 202 as shown in FIG. 17. Once a SmartTask 196 has been selected, the user may elect to follow 204 SmartTask 196 via a software platform 206, this platform may be separate or the same as portal 193. Following 204 enables a user to receive updates 205 about the content of SmartTask 196, which may then be disseminated 207 via platform 206 and/or portal 193 to all users 202 assigned SmartTask 196 or disseminated to any and all users adding SmartTask 196 to their own user library 198.

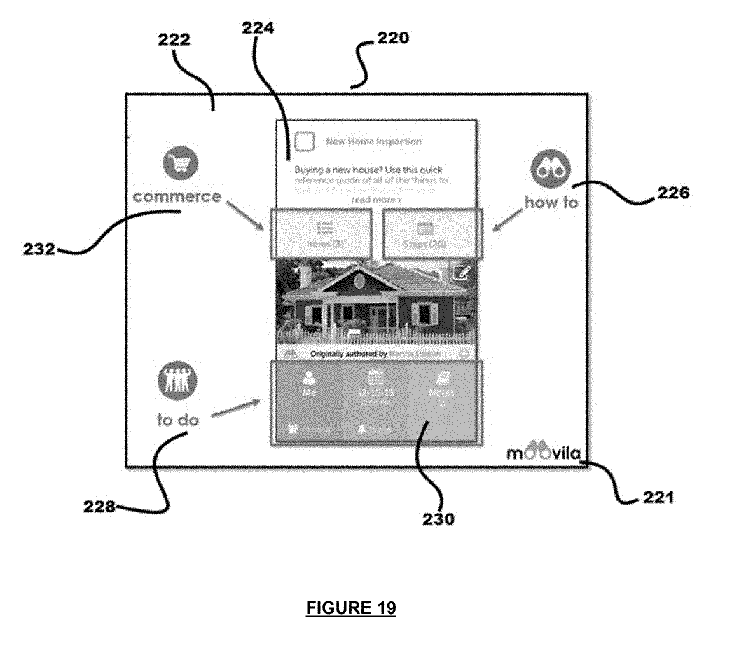

FIG. 19 illustrates one example 220 of a SmartTask 222 that may be displayed to a user via a portal, internet site, etc. 221, as known to those of skill in the art. One such example may be the MOOVILA™ platform provided by Moovila, LLC, Charleston, S.C. For purposes of example only and not intended to be limiting, SmartTask 222 is a reference guide to buying a new house 224. How To guide 226 may be provided for access by the user as well as a To Do list 228 that denotes activities the user should perform, as mentioned supra, scheduling 230 may be included in order to help the user establish a timeframe of milestone events to accomplish SmartTask 222. Commerce Tab 232 may provide links to local businesses a user may wish to employ or consult, such as realtors, home inspectors, building contractors, etc., in order to complete SmartTask 222 and buy a house.

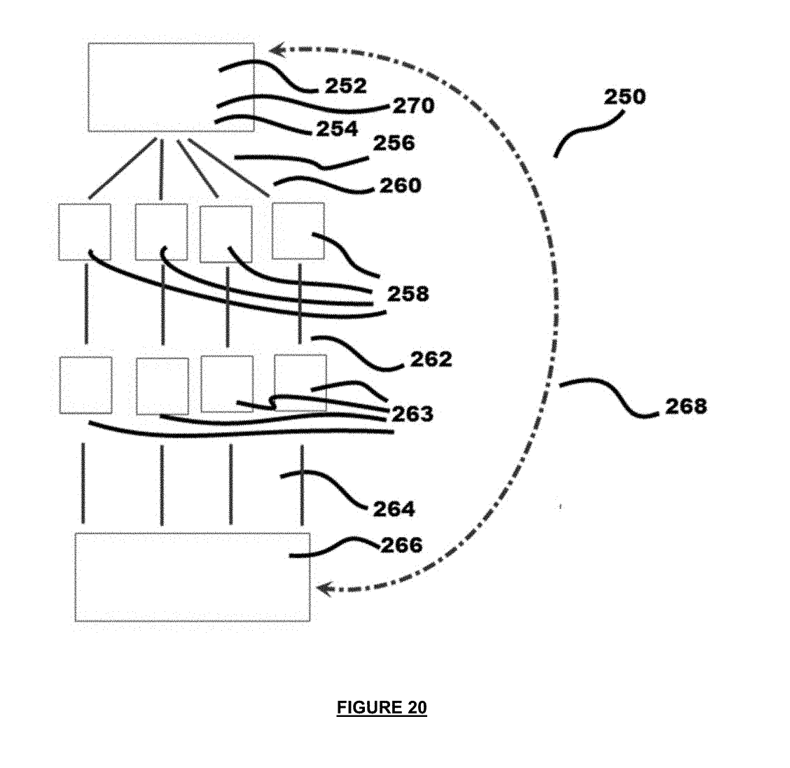

In addition to providing standalone activities, processes and actionable tasks, the current disclosure may also be linked to larger project frameworks so that users may coordinate activities into larger scale activities. For example, see FIG. 20, the current disclosure may be used with a Corporate Missions and Strategies SmartTask 250. The current disclosure may be used to assist organizations with managing the complex needs associated with organizational mission and strategy, standardized practices, and compliance procedures. For purposes of example only, corporate imperatives and goals 252 may be established 254 and deployed 256 to stakeholders 258 in a corporate organization, not shown. Deployment may be accomplished by a program 260 such as the ME Vision™ mobile content collaboration platform available from Moovila LLC. At step 262, stakeholders 258 are linked to the imperatives and goals 252. Linking entails shareholders 258 are assigned various tasks 263, whether individual or collaborative tasks involving a single stakeholder or joint cooperation of multiple stakeholders, associated with their respective roles in the organization and report progress of same 264 via program 260 to leadership 266. Once reporting is received, leadership 266 may then further enhance 268 imperatives and goals 252 and deploy 256 the revised imperatives and goals 270 for further effort by the stakeholders 258.

Process 250 overcomes failings with traditional corporate mission communication. For example, without use of the current disclosure, corporate leadership creates a strategic mission, which is then disparately communicated to stakeholders via numerous communication channels such as emails, meetings, posters, conference calls, etc. Once communicated via these sundry and various means, limited, at best, stakeholder comprehension is achieved. Typically, the stakeholders resume their previous activities unaware of the mission and goals. Leadership then struggles to gauge process on the corporate mission.

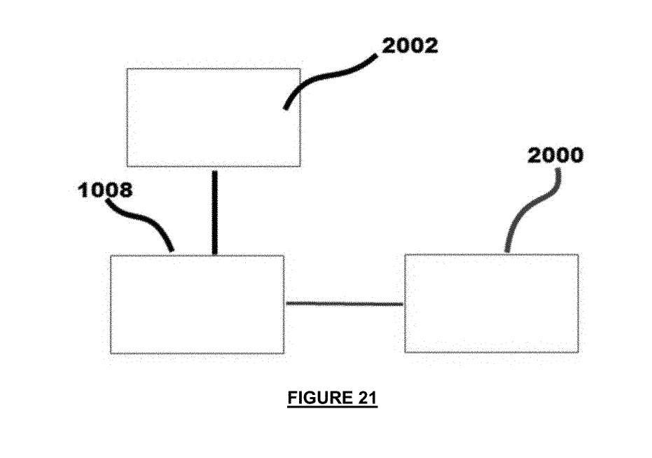

Platform 1008, in one embodiment as shown by FIG. 21, uses standard communications technologies and/or protocols. Thus, platform 1008 may include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on platform 1008 may include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over platform 1008 may be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, platform 1008 can also include links to other networks such as the Internet.

In various embodiments, platform 1008 may work with a computing device 2000 to retrieve web, or other, content via platform 1008 and displays it to a user. The computing device 2000 can be a personal computer (PC), a desktop computer, a laptop computer, a notebook, a tablet PC executing an operating system, for example, a Microsoft Windows-compatible operating system (OS), Apple OS X, and/or a Linux distribution. In another embodiment, computing device 2000 can be a device having computer functionality, such as a personal digital assistant (PDA), mobile telephone, video game system, etc. Computing device 2000 has functionality to connect to platform 1008 using one or more network protocols described in the specification above. For example, the computing device can include a modem, an Ethernet card, a wireless network card and the like to send and receive data from platform 1008.

Platform 1008 may execute on a computing device to interface with a user by receiving user inputs and displaying digital content to the user. In one instance, platform 1008 may display digital content retrieved from a third-party website 2002 to a user. Platform 1008 may include web browsers, news applications, games, social networking system applications, video content viewing applications etc. Examples of applications platform 1008 may operate in conjunction with include but are not limited to INTERNET EXPLORER, GOOGLE CHROME, APPLE SAFARI and MOZILLA FIREFOX.

The current disclosure provides organizations with a comprehensive solution to manage the continual lifecycle of their core missions, strategies and projects. Stakeholders, via a proprietary mobile-first platform, may easily engage the mission and identify their contributions to the greater goals of the enterprise. Based on the current disclosure, productivity and social learning functionality enable organizational knowledge to be shared, leveraged and used to accelerate the execution of organizational goals. The current disclosure eliminates the costly, time consuming and frequently inaccurate manual process of mission and project updates. The current disclosure provides a real-time cadence on the status of an organizational mission and means that board members, strategists and key leadership always have their finger on the pulse of the organizational efforts.

In a further embodiment, a mobile project and task management engine is provided. The mobile project and task management engine comprises a collaboration platform for distributing and receiving a distributed task. The collaboration platform includes at least one communication channel for distributing the task and provides an items list and a steps list relating to the distributed task. The collaboration platform also includes a social learning functionality allowing input regarding the distributed task.

In a further embodiment, an user paradigm is provided. The paradigm includes providing a collaboration platform and distributing a task via the collaboration platform. The collaboration platform provides at least one media channel relating to the task as well as a two-way messaging center within the collaboration platform. The collaboration platform allows modification of the task via social learning functionality.

The current disclosure, via a content distribution platform, distributes compliant, consistent, procedure and process to ensure successful execution of organizational imperatives and day-to-day operations through. The current disclosure allows an organization to deploy key imperatives and goals to all stakeholders throughout the organizational ecosystem from board members through individual contributors. Further, the current disclosure links Missions, Strategies and Projects to Real World Day-To-Day Activities via a “consumer first” user-interaction paradigm. Thus, the activities of the workforce can be linked and updated in a meaningful way to the core imperatives outlined by the leadership.

The current disclosure provides a mobile project and task management engine which yields an updated and consistent status of “where you are” that no longer requires hundreds of phone calls and wild guesses resulting in inaccurate outcomes. The content distribution platform of the current disclosure means an organization may easily publish and control the content stakeholders need to successfully execute their job roles in an efficient, compliant and controlled fashion. The current disclosure allows social learning that allows an organization to harvest the organizational wisdom that is essential to continuity, growth and compliance via input from those performing the tasks or those who have performed them previously. The current disclosure is a scalable and cost effective way to deploy mentorship across geographic and institutional boundaries. The current disclosure employs a “mobile-first” solution designed to ensure that communication channels are continually open and the execution of objectives and duties are updated as they are completed.

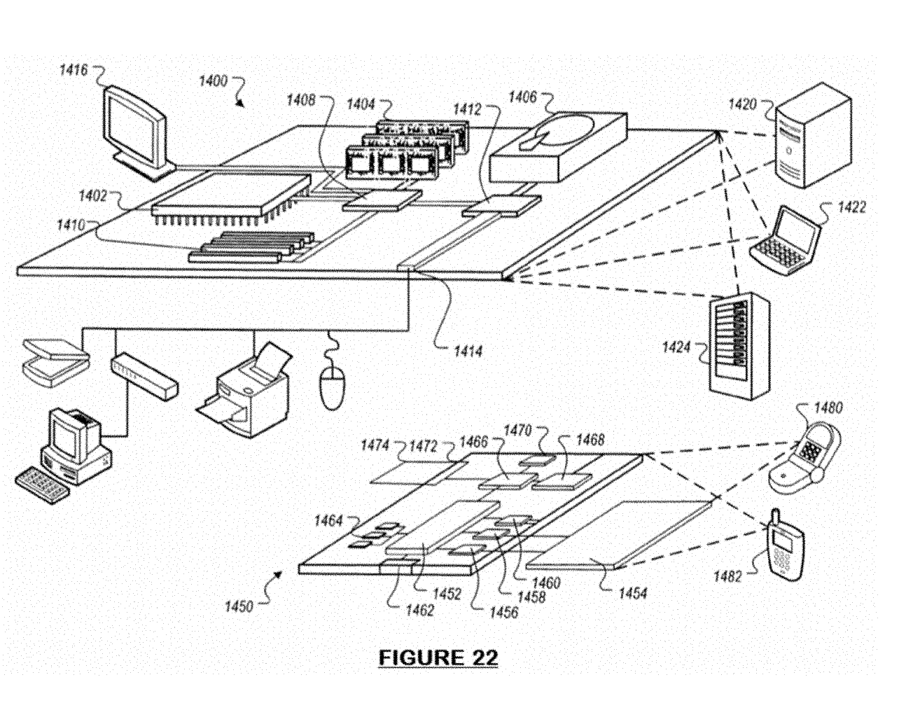

FIG. 22 shows an example of a generic computer device 1400 and a generic mobile computer device 1450, which may be used to implement the processes described herein, including the mobile-side and server-side processes for installing a computer program from a mobile device to a computer. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412 are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple busses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port 1414, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468 are interconnected using various busses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provide as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, memory on processor 1452, or a propagated signal that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, Wi-Fi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A method performed by one or more processing devices, comprising:
providing a project ecosystem containing a library of task media content to a user through an audio/visual display;
presenting to the user via the audio/visual display, an option to select one or more task media content applications for review; and
providing the user via the audio/visual display a task management engine, after one or more task media content has been selected, wherein the task management engine informs the user of steps necessary to complete the task media content.

2. The method of claim 1, wherein the task media content includes videos, written lists of information, audio files, weblinks, or combinations of the above.

3. The method of claim 1, wherein the user may save the one or more media task content applications to a computer or server.

4. The method of claim 1, wherein the project ecosystem, through the audio/visual display, allows the user to distribute the task media content to at least one other user.

5. The method of claim 1, wherein the project ecosystem, through the audio/visual display, allows the user to collaborate with at least one other user in order to complete the task media content.

6. The method of claim 1, wherein the project ecosystem, via the audio/visual display, allows a user to access providers of materials necessary to complete the steps dictated by the task management engine.

7. The method of claim 1, wherein the task management system, via the audio/visual display, sends updates regarding progress of accomplishing the task media content.

8. A mobile project and task management ecosystem comprising:
a collaboration platform for distributing and receiving a distributed task;
the collaboration platform including at least one communication channel for distributing a task;
the collaboration platform providing an items list and a steps list relating to the distributed task;
the collaboration platform including a social learning functionality allowing input regarding the distributed task; and
a smart content library function allowing personalized retrieval and storage of relevant instruction and resource definition for the distributed task.

9. The mobile project and task management ecosystem of claim 8, wherein the collaboration platform assigns different tasks to various users via the at least one communication channel.

10. The mobile project and task management ecosystem of claim 8, wherein the project ecosystem, through the audio/visual display, allows the user to collaborate with at least one other user in order to complete the task.

11. The mobile project and task management ecosystem of claim 8, wherein the collaboration platform, via an audio/visual display, allows a user to access providers of materials necessary to complete the task.

12. The mobile project and task management ecosystem of claim 8, wherein the collaboration platform, via an audio/visual display, sends updates regarding progress of accomplishing the task.

13. An interactive user paradigm comprising:
providing a collaboration platform;
distributing a task via the collaboration platform;
the collaboration platform providing at least one media channel relating to the task;
providing a two-way messaging center within the collaboration platform; and
allowing modification of the task via social learning functionality.

14. The interactive user paradigm of 13, wherein social learning functionality is accomplished via harvesting information via the two-way messaging center from a user of the interactive user paradigm.

15. The interactive user paradigm of 13, wherein the collaboration platform enables access to a third-party website and the ability to retrieve and display content from the third party website.

16. The interactive user paradigm of 13, wherein the collaboration platform, through an audio/visual display, allows a user to collaborate with at least one other user in order to complete the task media content.

17. The interactive user paradigm of 13, wherein the collaboration platform, via an audio/visual display, allows a user to access providers of materials necessary to complete the task dictated by the collaboration platform.

18. The interactive user paradigm of 13, wherein the collaboration platform, via an audio/visual display, sends updates regarding progress of accomplishing the task.
